(19) United States
(12) Patent Application Publication
(10) Pub. No.: US 2024/0093719 A1
(43) Pub. Date: Mar. 21, 2024

(54) HOOK ASSEMBLY

(71) Applicant: Quzhou T-NINE Trading Co., Ltd., Quzhou (CN)

(72) Inventor: John SU, Quzhou (CN)

(21) Appl. No.: 18/520,521

(22) Filed: Nov. 27, 2023

(30) Foreign Application Priority Data
Feb. 28, 2023 (CN) 202310176031.1
Jul. 5, 2023 (CN) 202321757496.8

(51) Int. Cl. F16B 45/00

(52) U.S. Cl. CPC F16B 45/00

(57) ABSTRACT

A hook assembly, including a hook and a connecting member. The connecting member is configured to mount the hook on a mounting base. The connecting member is sliding mounting member, hanging member, or fixing member. The hook includes a hook body, a plate, an upper hook portion, and a lower hook portion. the hook body is fixedly provided on an outer side of the plate. The upper hook portion is arranged on an upper end of the plate and is configured to bend inward. The lower hook portion is arranged at a lower end of the plate and is configured to bend inward. Both the upper hook portion and the lower hook portion are slidably connected to a track on a surface of a sliding mounting member and are fittedly inserted therein.

### CROSS-REFERENCE TO RELATED APPLICATIONS

This application claims the benefit of priority from Chinese Patent Applications No. 202310176031.1 and No. 202321757496.8, filed on Feb. 28, 2023 and Jul. 5, 2023, respectively. The content of the aforementioned application, including any intervening amendments thereto, is incorporated herein by reference in its entirety.

### TECHNICAL FIELD

The present disclosure relates to household products, and more particularly to a hook assembly.

### BACKGROUND

Hooks are daily necessities mounted on the wall for hanging items, such as bicycle hooks for hanging bicycles.

The mounting methods of the existing hooks are limited, and the hooks are generally fixed or hung on the wall or shelf. Moreover, the hooks may be slidably mounted on a track fixed to the wall, so as to flexibly adjust the position of the hooks.

If it is needed to use the same model in different installation scenarios, the above hooks cannot achieve this purpose.

### SUMMARY

The technical problem to be solved by this application is to provide a hook assembly which can be mounted in a variety of application scenarios.

This application provides a hook assembly, comprising:
a hook; and
a connecting member;
wherein the connecting member is configured to mount the hook on a mounting base; the connecting member is a sliding mounting member, a hanging member, or a fixing member;
the hook comprises:
a hook body;
a plate;
an upper hook portion; and
a lower hook portion;
the hook body is fixedly provided on an outer side of the plate; the upper hook portion is arranged on an upper end of the plate, and is configured to bend inward; the lower hook portion is arranged at a lower end of the plate, and is configured to bend inward; when the connecting member is the sliding mounting member, the upper hook portion and the lower hook portion are configured to fit a track on a surface of the sliding mounting member to be slidably connected with the sliding mounting member, and the sliding mounting member is fixedly provided on a mounting surface; and
the plate is provided with a mounting through hole; when the connecting member is the hanging member or the fixing member, the hanging member or the fixing member is configured to fittingly pass through the mounting through hole to be connected to the mounting surface, so as to mount the plate to the mounting surface; and an inner end of the upper hook portion is flush with an inner end of the lower hook portion so that inner ends of the upper hook portion and the lower hook portion are configured as an abutting portion to abut against and limit the mounting surface.

In an embodiment, the number of the upper hook portion is two, and upper hook portions are symmetrically distributed on both sides of the upper end of the plate; the number of the lower hook portion is two, and two lower hook portions are symmetrically distributed on both sides of the lower end of the plate; the mounting base is columnar; and a distance between the two upper hook portions is the same as a distance between the two lower hook portions to insert the hook on an outside of the mounting base.

In an embodiment, the plate is provided with an extending plate extending from a middle of the upper and/or lower end of the plate; an end face of the extending plate is configured to abut against a surface of the mounting base when the connecting member is selected for the hanging member; and the extending plate is located between the two upper hook portions or the two lower hook portions.

In an embodiment, hanging member further comprises:
a locking screw; and
a hanging nut;
the hanging nut comprises a rotation-stop post, a limiting post and a hanging post sequentially arranged in a coaxial manner, and outside diameters of the rotation-stop post, the limiting post and the hanging post are sequentially ascending;
a periphery of the rotation-stop post is provided with a tangent surface to be matchingly embedded in the mounting through hole to stop rotation of the hanging nut;
an outer diameter of the limiting post is greater than that of the rotation-stop post to form a limiting step, and the limiting step is configured to abut against a first surface of the plate to limit movement of the hanging nut;
an outer diameter of the hanging post is greater than that of the limiting post to form a hanging step; the hook further comprises a mounting member provided with a hanging hole; the limiting post is embedded in the hanging hole; a length of the limiting post is the same as a thickness of the mounting member; the hanging step is configured to abut against a first surface of the mounting member, and the first surface of the plate is configured to abut against a second surface of the mounting member; and
the locking screw is threadedly connected within the rotation-stop post and a nut of the locking screw abuts against a second surface of the plate to lock the hanging member and the hook.

In an embodiment, the mounting base comprises a support rod; a surface of the support rod is provided with a plurality of hanging holes; an inner diameter of an upper portion of the plurality of hanging holes is larger than an inner diameter of a lower portion of each of the plurality of hanging holes; the plurality of hanging holes are configured to allow the hanging member to be embedded therein, and an outer diameter of a portion of the hanging member inside the plurality of hanging holes is matched with the inner diameter of the lower portion of each of the plurality of hanging hole to fix the hanging member; a maximum outer diameter of the hanging member is smaller than or equal to a maximum inner diameter of each of the plurality of hanging holes to allow the hanging member to pass through the plurality of hanging holes to be mounted on the support rod.

In an embodiment, the upper hook portion is arch-shaped, and the lower hook portion is horizontal; an upper end of the lower hook portion is provided with a resilient clamping piece; the track of the sliding mounting member comprises an upper track portion and a lower track portion; the upper hook portion is matched with the upper track portion of the sliding mounting member; the resilient clamping piece is matchingly embedded in the lower track portion of the sliding mounting member; the resilient clamping piece is configured to be deformed to be detached from the lower track portion, so as to allow the hook to flip upward and to compress the resilient clamping piece to be removed from the sliding mounting member.

In an embodiment, a bend angle of an outer end of an arch-shaped portion of the upper hook portion is less than an arc angle corresponding to the upper track portion of the sliding mounting member, so as to reserve a clearance between the outer end of the arch-shaped portion and the upper track portion during mounting.

In an embodiment, the sliding mounting member comprises a fixing sheet and a sliding sheath;
the fixing sheet is fixedly provided on the mounting base; the sliding sheath is provided on an outer side of the fixing sheet;
both ends of the sliding sheath are sleevedly provided on the outer side of the fixing sheet; the sliding sheath is slidably connected with the fixing sheet, and is fixed through a locking member to adjust a position of the sliding sheath; an upper end and a bottom end of the sliding sheath are each provided with the track to correspondingly mount the upper hook portion and the lower hook portion.

In an embodiment, an outer end of the fixing sheet is fixedly provided with a plurality of limiting rods with an internal threaded hole in a length direction; two ends of the sliding sheath are each provide with a plurality of limiting through holes; the plurality of limiting rods are fittedly embedded in the plurality of limiting through holes to mount the sliding sheath; the number of limiting holes among the plurality of limiting through holes embedded with the plurality of limiting rods is selectable so as to facilitate a relative movement of the sliding sheath and the fixing sheet; the sliding mounting member further comprises a plurality of siding screws, which are correspondingly arranged inside the plurality of limiting rods to abut against and lock the sliding sheath.

In an embodiment, the fixing sheet is mounted on an upright column corresponding to a wall; the fixing sheet is provided with a plurality of nail holes in a length direction; and when the fixing sheet is mounted to the upright column, at least one of the plurality of nailed holes is located on a mounting surface of the upright column.

In an embodiment, an outer end of at least one of the upper hook portion and the lower hook portion is bendingly provided with a pressure-reduction plate arranged vertically; the pressure-reduction plate is configured to extend in a direction away from a center of the hook; and an end face of the pressure-reduction plate is configured to abut against a surface of the mounting base when the connecting member is the fixing member.

In an embodiment, the fixing member comprises an expansion tube and a screw; the expansion tube is embeddedly provided in the mounting base; the screw is configured to abut against a surface of the plate and run through the mounting through hole to be threadedly connected in the expansion tube.

In an embodiment, the mounting through hole is a waist-shaped slot hole.

Compared to the prior art, the beneficial effects of the present disclosure are as follows.

1. The outer end surfaces of the upper hook portion and the lower hook portion of the hook are flush, can be configured as an abutting surface to directly abut against the wall when using fasteners between the hooks and the wall surface. The outer end of the upper hook portion is bent and flipped to the upper side to form a pressure-reduction plate, and the pressure-reduction plate is arranged vertically to ensure that the hook can be stabilized against the wall to reduce loosening.

2. The upper hook portion and the lower hook portion of the hook can also be slidably connected with the sliding mounting member fixed on the wall, and the hooks can be adjusted to change the mounting position at will, facilitating broadening the application scenario.

3. The distance between the two upper hook portions and the two lower hook portions is the same, and the width of the support rods is the same, so that the hooks can be placed in different positions of the support rods by means of the mounting parts.

4. The sliding mounting member includes a fixing sheet and a sliding sheath, the sliding sheath is provided on the outer side of the fixing sheet; the fixing sheets are correspondingly nailed on a upright column of a wall; and each of the fixing sheet has one nail hole provided on the mounting surface of the upright column. The number of limiting through holes and limiting posts between the fixing sheet and the sliding sheath can be selected to adopt the different spacing requirements of the upright column of a wall in different countries and regions. That is, as long as the fixing sheet can be fixed to the upright column, the sliding sheath are able to be fixed to the fixing sheet, only the use of the number of limit holes are different.

5. The extending plate is provided between the two upper hook portions, and is configured to abut the support rod to increase the access area and improve the installation stability.

6. The hanging member further includes a locking screw and a hanging nut. The hanging nut comprises a rotation-stop post, a limiting post, and a hanging post that are arranged in a sequential coaxial manner and have sequentially increasing outside diameters. The rotation-stop post has a waist-shaped cross section, and can be inserted in a corresponding waist-shaped mounting through holes to avoid rotation of the hanging nuts and to stop the rotation of the locking screw and the hanging nut during installation. The limiting step formed by the limiting post can abut against the back of the plate to enable the limiting post to act as a nut to automatically lock the hook after the mounting nut is locked by the locking screw.

The outer diameter of the hanging post is larger than the limiting post, so that the limiting post between the hanging post and the plate can be hung on the hanging hole of the support rod as a hanging component. The hanging hole is an irregular-shaped hole with a round hole at the top and a small waist-shaped slot hole at the bottom and the upper size of the hanging hole is larger than the lower. The size of the round hole is larger than the outside diameter of the hanging post, and the outside diameter of the limiting post is equal to the caliber of the waist-shaped slot hole, so that the hanging nut can automatically move downward to be limited under the action of gravity after passing through the round hole, allowing for convenient installation.

### DESCRIPTION OF THE DRAWINGS

FIG. 1 is a structural diagram of a hook according to an embodiment of the present disclosure;

FIG. 2 schematically shows sliding assembly of the hook according to an embodiment of the present disclosure;

FIG. 3 is an exploded view of the hook and a sliding mounting member according to an embodiment of the present disclosure;

FIG. 4 schematically shows assembly of a fixing sheet and an upright column according to an embodiment of the present disclosure;

FIG. 5 schematically shows the hook according to an embodiment of the present disclosure in a mounted state;

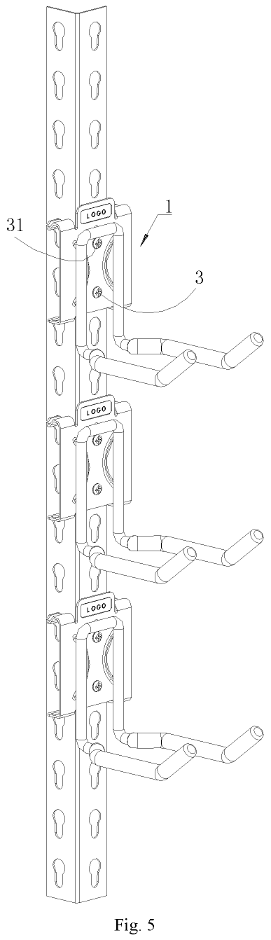

FIG. 6 is a structural diagram of a hanging nut and the hook according to an embodiment of the present disclosure;

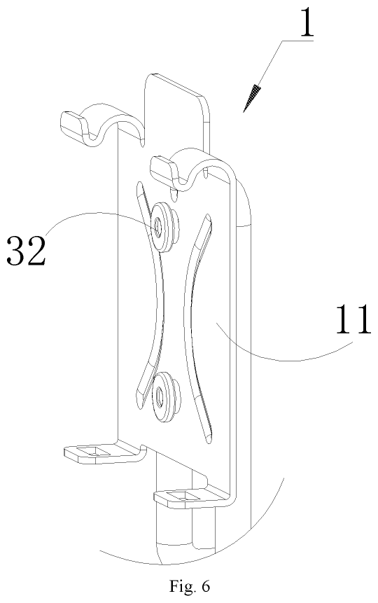

FIG. 7 is a structural diagram of the hanging nut and a shelf according to an embodiment of the present disclosure;

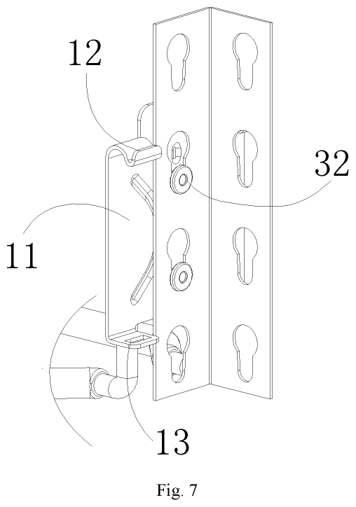

FIG. 8 is a structural diagram of the hanging nut according to an embodiment of the present disclosure;

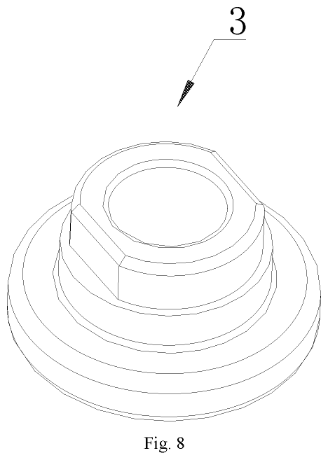

FIG. 9 schematically shows fixed installation of the hook according to an embodiment of the present disclosure; and

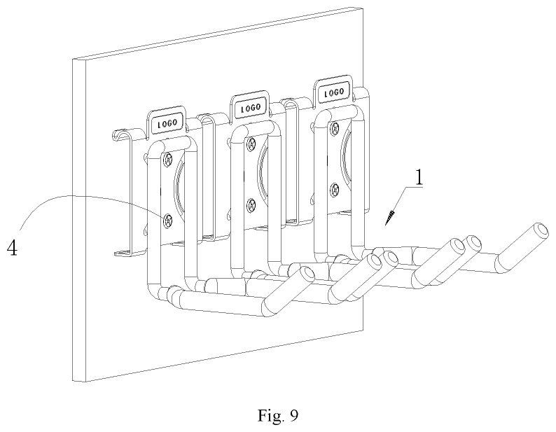

FIG. 10 is an exploded view of a fixing member according to an embodiment of the present disclosure.

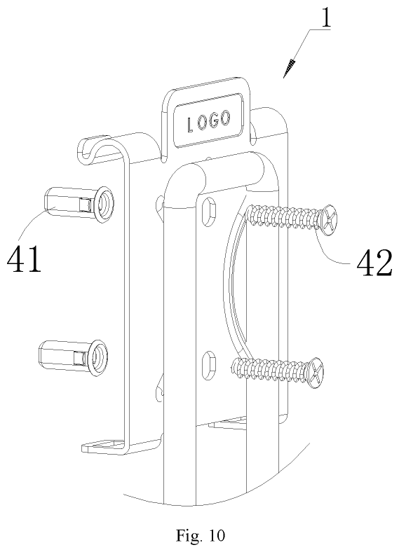

In the drawings:
1. hook; 11. plate; 12. upper hook portion; 13. lower hook portion; 14. hook body;
2. sliding mounting member; 21. siding sheath; 22. fixing sheet;
3. hanging member; 31. locking screw; 32. hanging nut;
4. fixing member; 41. expansion tube; and 42. screw.

### DETAILED DESCRIPTION OF EMBODIMENTS

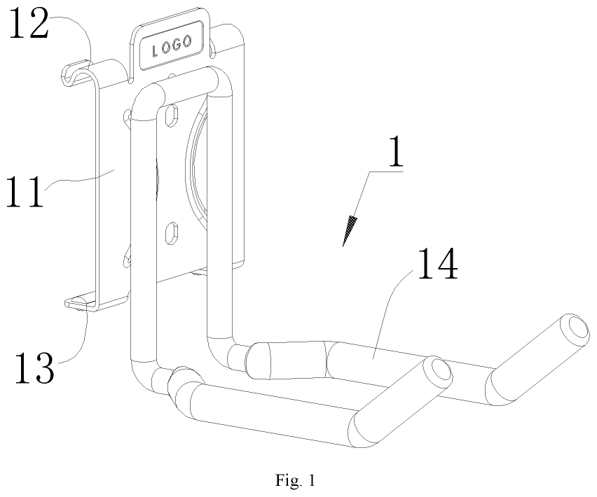

Referring to FIG. 1, the hook 1 provided in the present disclosure can be mounted on at least three different mounting bases, and several connecting members are correspondingly used for different mounting bases.

The hook 1 includes a hook body 14, a plate 11, an upper hook portion 12, and a lower hook portion 13. The hook body 14 is fixedly provided on an outer side of the plate 11. The upper hook portion 12 is arranged on an upper end of the plate 11 and is configured to bend inward. The lower hook portion 13 is arranged at a lower end of the plate 11 and is configured to bend inward. When the connecting member is the sliding mounting member, the upper hook portion 12 and the lower hook portion 13 are configured to fit a track on a surface of the sliding mounting member to be slidably connected to a track on a surface of a sliding mounting member 2 and are fittedly inserted therein. The sliding mounting member 2 is fixedly provided on a mounting surface. An inner end of the upper hook portion 12 is flush with an inner end of the lower hook portion 13 (refer to the ends away from plate 11) so that inner ends of the upper hook portion 12 and the lower hook portion 13 are configured as an abutting portion to abut against and limit the mounting surface.

Besides, the plate 11 is provided with a plurality of mounting through holes, so that it can be connected with other styles of mounting bases with nails through the mounting through holes. The mounting through hole is a waist-shaped slot hole to adjust the mounting position of the nails or to match the nails with irregular shape.

The number of the upper hook portion 12 is two, and two upper hook portions 12 are symmetrically distributed on both sides of the upper end of the plate 11. The number of the lower hook portion 13 is two, and two lower hook portion 13 are symmetrically distributed on both sides of the lower end of the plate 11. A distance between the two upper hook portions 12 is the same as a distance between the two lower hook portions 13 and matches a width of a mounting base with a cylindrical-shape, so that the hook 1 can be insertedly provided on an outside of the mounting base.

The upper hook portion 12 is arch-shaped, and the lower hook portion 13 is horizontal. An upper end of the lower hook portion 13 is provided with a resilient clamping piece to enable the upper hook portion 12 and the lower hook portion 13 can be slidably inserted in a corresponding track when the hook 1 is installed on a mounting base with a flat-shape through the sliding mounting member which has a track.

The plate 11 is provided with an extending plate extending from a middle of the upper and/or lower end of the plate 11. An end face of the extending plate is configured to abut against a surface of the mounting base when the hook 1 is mounted on the mounting base. The extending plate is located between the two upper hook portions 12 or the two lower hook portions 13 to improve the stability of the installation.

An outer end of the upper hook portion 12 and/or the lower hook portion 13 is bendingly provided with a pressure-reduction plate arranged vertically. The pressure-reduction plate is bent in a direction away from a center of the hook 1. An end face of the pressure-reduction plate is configured to abut against a surface of the mounting base when the hook 1 is directly mounted on the mounting base with a flat-shape, which can also improve the stability of the installation.

### Embodiment 1

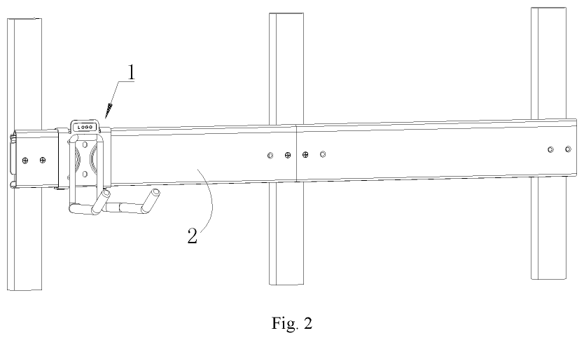

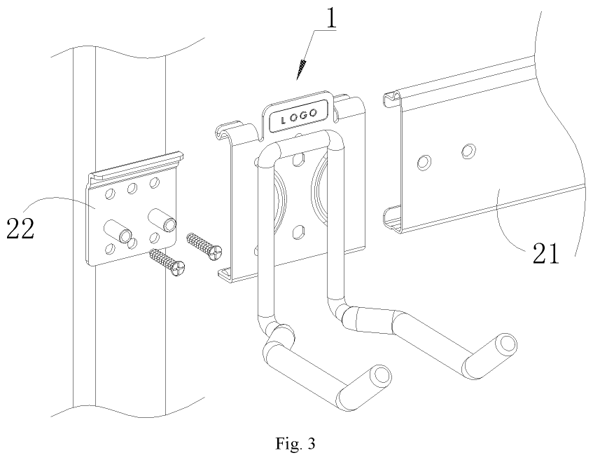

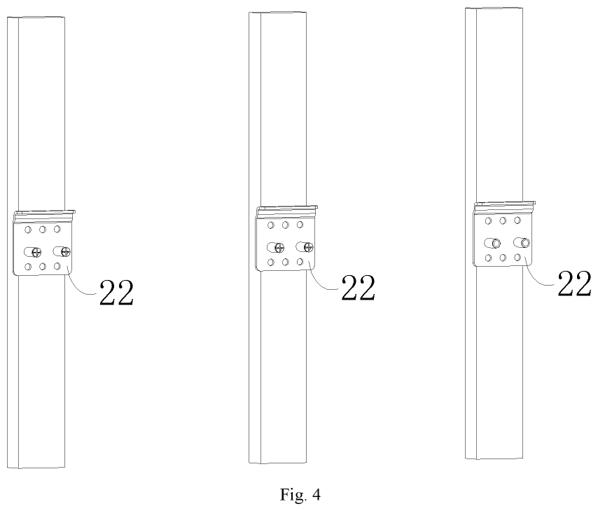

This embodiment provides a hook assembly in which the hook 1 is mounted on a mounting base by means of a sliding mounting member 2, as shown in FIGS. 2-4. The hook assembly includes a hook 1 and a sliding mounting member 2. The mounting base of this embodiment is a wooden wall with a plurality of wooden columns evenly distributed inside and wall panels covered outside the surface, which is common in the United States, Europe and other countries and regions.

The upper hook portion 12 is matched with an upper track portion of the sliding mounting member 2. A resilient clamping piece is fittedly inserted in a bottom track portion of the sliding mounting member. The resilient clamping piece can be deformed to detach from the bottom track portion, allowing the hook to flip upward and to compress to deform the resilient clamping piece to be removable from the sliding mounting member. When the upper hook portion 12 and the lower hook portion 13 are inserted in the corresponding track, the resilient clamping piece is kept compressed to limit sliding of the hook 1 and ensure that the hook 1 is firmly fixed in a setting position. But the setting position can be any position in the track.

A bend angle of an outer end of an arch-shaped portion of the upper hook portion 12 is less than an arc angle corresponding to the upper track portion of the sliding mounting member 2, so as to reserve a clearance between the outer end of the arch-shaped portion and the upper track portion during mounting. That is, in the installation, the upper hook portion 12 can be inserted in the upper track portion, at this time the outer end of an arch-shaped portion is fitted with a track, and then the lower hook portion 13 is pressed into the track and buckle, thus the outer end of the arch-shaped portion and the track to maintain a gap, in order to retain a clearance between the outer end of the arch-shaped portion and the track, which facilitates the installation of the hook 1 and the sliding mounting member 2.

The sliding mounting member 2 includes a fixing sheet 22 and a sliding sheath 21. The fixing sheet 22 is fixedly provided on the mounting base. The sliding sheath 21 is provided on an outer side of the fixing sheet 22. Both ends of the sliding sheath 21 are sleevedly provided on the outer side of the fixing sheet 22. The sliding sheath 21 is slidably connected with the fixing sheet 22, and is fixed through a locking member to adjust a position of the sliding sheath 21. An upper end and a bottom end of the sliding sheath 21 are each provided with the track to correspondingly mount the upper hook portion 12 and the lower hook portion 13.

In an embodiment, an outer end of the fixing sheet 22 is fixedly provided with a plurality of limiting rods with an internal threaded hole in a length direction. Both ends of the sliding sheath 21 are each provided with a plurality of limiting through holes, in which the plurality of limiting rods are fittedly inserted to mount the sliding sheath 21. The number of the plurality of limiting through holes insertedly provided with the plurality of limiting rods is selectable so as to facilitate the relative movement of the sliding sheath 21 and the fixing sheet 22. The sliding mounting member 2 further includes a plurality of siding screws, which are mounted in the corresponding limiting rods and abuts against and locks the sliding sheath 21.

In an embodiment, the fixing sheet 22 is installed on an upright column corresponding to a wall. The fixing sheet 22 is provided with a plurality of nail holes in a length direction. And when the fixing sheet 22 is mounted to the upright column with at least one of the plurality of nailed holes is located on a mounting surface of the upright column.

### Embodiment 2

The hanging member 3 includes a locking screw 31 and a hanging nut 32. The hanging nut 32 includes a rotation-stop post, a limiting post, and a hanging post sequentially arranged in a coaxial manner, and outer diameters of the rotation-stop post, the limiting post and the hanging post are sequentially ascending. A periphery of the rotation-stop post is provided with a tangent surface to be matchingly embedded in the mounting through hole to stop rotation of the hanging nut 32. An outer diameter of the limiting post is greater than that of the rotation-stop post to form a limiting step. And the limiting step is configured to abut against a first surface of the plate 11 to limit the movement of the hanging nut 32.

An outer diameter of the hanging post is greater than that of the limiting post to form a hanging step. The hook further comprises a mounting member provided with a hanging hole. The limiting post is embedded in the hanging hole of a mounting member of the hook 1. A length of the limiting post is the same as a thickness of the mounting member. The hanging step is configured to abut against a first surface of the mounting member of the hook 1, and the first surface of the plate 11 is configured to abut against a second surface of the mounting member to hang the hook 1.

The locking screw 31 is threadedly connected within the rotation-stop post and a nut of the locking screw 31 abuts against a second surface of the plate 11 to lock the hanging member 3 and the hook 1.

In an embodiment, the mounting base includes a support rod. A surface of the support rod is provided with a plurality of hanging holes. An inner diameter of an upper portion of each of the plurality of hanging holes is larger than an inner diameter of a lower end portion of each of the plurality of hanging holes.

The plurality of hanging holes are configured to allow the hanging member 3 to be embedded therein, and an outer diameter of a portion of the hanging member 3 inside the plurality of hanging holes is matched with the inner diameter of the lower portion of each of the hanging holes to fix the hanging member 3. A maximum outer diameter of the hanging member 3 is smaller than or equal to a maximum inner diameter of each of the plurality of hanging holes to allow the hanging member 3 to pass through the plurality of hanging holes to be mounted on the support rod.

### Embodiment 3

A fixing member 4 includes an expansion tube 41 and a screw 42. The expansion tube 41 is insertedly provided in the mounting base. The screw 42 is configured to abut against a surface of the plate 11 and run through the mounting through hole to be threadedly connected in the expansion tube 41.

What is claimed is:

1. A hook assembly, comprising:
a hook; and
a connecting member;
wherein the connecting member is configured to mount the hook on a mounting base; the connecting member is a sliding mounting member, a hanging member, or a fixing member;
the hook comprises:
a hook body;
a plate;
an upper hook portion; and
a lower hook portion;
the hook body is fixedly provided on an outer side of the plate; the upper hook portion is arranged on an upper end of the plate, and is configured to bend inward; the lower hook portion is arranged at a lower end of the plate, and is configured to bend inward; when the connecting member is the sliding mounting member, the upper hook portion and the lower hook portion are configured to fit a track on a surface of the sliding mounting member to be slidably connected with the sliding mounting member, and the sliding mounting member is fixedly provided on a mounting surface; and
the plate is provided with a mounting through hole; when the connecting member is the hanging member or the fixing member, the hanging member or the fixing member is configured to fittingly pass through the mounting through hole to be connected to the mounting surface, so as to mount the plate to the mounting surface; and an inner end of the upper hook portion is flush with an inner end of the lower hook portion so that the inner end of the upper hook portion and the inner end of the lower hook portion are configured as an abutting portion to abut against and limit the mounting surface.

2. The hook assembly of claim 1, wherein the number of the upper hook portion is two, and two upper hook portions are symmetrically distributed on both sides of the upper end of the plate; the number of the lower hook portion is two, and two lower hook portions are symmetrically distributed on both sides of the lower end of the plate; the mounting base is columnar; and a distance between the two upper hook portions is the same as a distance between the two lower hook portions to insert the hook on an outer side of the mounting base.

3. The hook assembly of claim 2, wherein the plate is provided with an extending plate extending from a middle of the upper and/or lower end of the plate; an end face of the extending plate is configured to abut against a surface of the mounting base when the connecting member is the hanging member; and the extending plate is located between the two upper hook portions or the two lower hook portions.

4. The hook assembly of claim 1, wherein the hanging member comprises a locking screw and a hanging nut;
the hanging nut comprises a rotation-stop post, a limiting post and a hanging post sequentially arranged in a coaxial manner, and outer diameters of the rotation-stop post, the limiting post and the hanging post are sequentially ascending;
a periphery of the rotation-stop post is provided with a tangent surface to be matchingly inserted in the mounting through hole to stop rotation of the hanging nut;
an outer diameter of the limiting post is greater than that of the rotation-stop post to form a limiting step, and the limiting step is configured to abut against a first surface of the plate to limit movement of the hanging nut;
an outer diameter of the hanging post is greater than that of the limiting post to form a hanging step; the hook further comprises a mounting member provided with a hanging hole; the limiting post is inserted in the hanging hole; a length of the limiting post is the same as a thickness of the mounting member; the hanging step is configured to abut against a first surface of the mounting member, and the first surface of the plate is configured to abut against a second surface of the mounting member; and
the locking screw is threadedly connected within the rotation-stop post, and a nut of the locking screw abuts against a second surface of the plate to lock the hanging member and the hook.

5. The hook assembly of claim 1, wherein the mounting base comprises a support rod; a surface of the support rod is provided with a plurality of hanging holes; an inner diameter of an upper portion of each of the plurality of hanging holes is larger than an inner diameter of a lower portion of each of the plurality of hanging holes; the plurality of hanging holes are configured to allow the hanging member to be inserted therein, and an outer diameter of a portion of the hanging member inside the plurality of hanging holes is matched with the inner diameter of the lower portion of each of the plurality of hanging holes to fix the hanging member; a maximum outer diameter of the hanging member is smaller than or equal to a maximum inner diameter of each of the plurality of hanging holes to allow the hanging member to pass through the plurality of hanging hole to be mounted on the support rod.

6. The hook assembly of claim 1, wherein the upper hook portion is arch-shaped, and the lower hook portion is horizontal; an upper end of the lower hook portion is provided with a resilient clamping piece; the track of the sliding mounting member comprises an upper track portion and a lower track portion; the upper hook portion is matched with the upper track portion of the sliding mounting member; the resilient clamping piece is matchingly inserted in the lower track portion of the sliding mounting member; the resilient clamping piece is configured to be deformed to be detached from the lower track portion, so as to allow the hook to flip upward and to compress the resilient clamping piece to be removed from the sliding mounting member.

7. The hook assembly of claim 6, wherein a bend angle of an outer end of an arch-shaped portion of the upper hook portion is less than an arc angle corresponding to the upper track portion of the sliding mounting member, so as to reserve a clearance between the outer end of the arch-shaped portion and the upper track portion during mounting.

8. The hook assembly of claim 1, wherein the sliding mounting member comprises a fixing sheet and a sliding sheath;
the fixing sheet is fixedly provided on the mounting base; the sliding sheath is provided on an outer side of the fixing sheet;
both ends of the sliding sheath are sleevedly provided on the outer side of the fixing sheet; the sliding sheath is slidably connected with the fixing sheet, and is fixed through a locking member to adjust a position of the sliding sheath; an upper end and a bottom end of the sliding sheath are each provided with the track to correspondingly mount the upper hook portion and the lower hook portion.

9. The hook assembly of claim 8, wherein an outer end of the fixing sheet is fixedly provided with a plurality of limiting rods with an internal threaded hole in a length direction; two ends of the sliding sheath are each provided with a plurality of limiting through holes; the plurality of limiting rods are fittedly inserted in the plurality of limiting through holes to mount the sliding sheath; the number of limiting through holes among the plurality of limiting through holes inserted with the plurality of limiting rods is selectable so as to facilitate a relative movement of the sliding sheath and the fixing sheet; the sliding mounting member further comprises a plurality of siding screws, which are correspondingly arranged inside the plurality of limiting rods to abut against and lock the sliding sheath.

10. The hook assembly of claim 9, wherein the fixing sheet is mounted on an upright column corresponding to a wall; the fixing sheet is provided with a plurality of nail holes in a length direction; and when the fixing sheet is mounted to the upright column, at least one of the plurality of nail holes is located on a mounting surface of the upright column.

11. The hook assembly of claim 1, wherein an outer end of at least one of the upper hook portion and the lower hook portion is bendingly provided with a pressure-reduction plate arranged vertically; the pressure-reduction plate is configured to extend in a direction away from a center of the hook; and an end face of the pressure-reduction plate is configured to abut against a surface of the mounting base when the connecting member is the fixing member.

12. The hook assembly of claim 1, wherein the fixing member comprises an expansion tube and a screw; the expansion tube is insertedly provided in the mounting base; the screw is configured to abut against a surface of the plate and run through the mounting through hole to be threadedly connected in the expansion tube.

13. The hook assembly of claim 1, wherein the mounting through hole is a waist-shaped slot hole.
